(19) United States
(12) Patent Application Publication
(10) Pub. No.: US 2025/0020781 A9
(43) Pub. Date: Jan. 16, 2025

(54) TIME-OF-FLIGHT DEVICE AND TIME OF FLIGHT SYSTEM WITH NANOSTRUCTURE LAYER

(71) Applicant: Sony Semiconductor Solutions Corporation, Kanagawa (JP)

(72) Inventor: Manuel Amaya-Benitez, Stuttgart (DE)

(73) Assignee: Sony Semiconductor Solutions Corporation, Kanagawa (JP)

(21) Appl. No.: 18/621,993

(22) Filed: Mar. 29, 2024

Related U.S. Application Data
(63) Continuation of application No. 16/573,196, filed on Sep. 17, 2019, now abandoned.

(30) Foreign Application Priority Data
Sep. 21, 2018 (EP) 18195851.3

(51) Int. Cl. G01S 7/481; G01S 17/10; G01S 17/32

(52) U.S. Cl. CPC G01S 7/4816; G01S 17/10; G01S 17/32

(57) ABSTRACT

The present disclosure pertains to a time-of-flight device having a photo-detection layer and a nanostructure layer arranged on the photo-detection layer. The nanostructure layer has a wavelength filtering function and a focusing function, such that the wavelength range of light incident on the nanostructure layer is reduced to a predefined wavelength range and light emitted from the nanostructure is focused on the photo-detection layer.

### CROSS REFERENCE TO RELATED APPLICATIONS

The present application claims the benefit of priority, under 35 U.S.C. § 120, as a continuation application of U.S. application Ser. No. 16/573,196, filed on Sep. 17, 2019, which claims priority to European Patent Application 18195851.3, filed on Sep. 21, 2018. Both applications are hereby incorporated by reference in their entirety.

### TECHNICAL FIELD

The present disclosure generally pertains to a time-of-flight device and a time-of-flight system including such a time-of-flight device.

### TECHNICAL BACKGROUND

Typically, known time-of-flight systems have a light source for illuminating a region of interest and a camera for detecting light stemming from the region of interest for determining a distance between the light source and the region of interest. The distance can be determined, for example, based on a phase shift of the light introduced when traveling from the light source to the camera, which, in turn, is associated with the distance, and it can be based, for example, on a roundtrip time of the light when traveling from the light source to the camera.

For detection of light in the time-of-flight technology, it is known to use image sensors having multiple pixels, wherein on each pixel a micro lens is arranged for focusing light onto the pixel.

Although there exist techniques for focusing and detecting light in time-of-flight device and systems, it is generally desirable to provide a time-of-flight device and a time-of-flight system.

### SUMMARY

According to a first aspect, the disclosure provides a time-of-flight device having a photo-detection layer, and a nanostructure layer arranged on the photo-detection layer, wherein the nanostructure layer has a wavelength filtering function and a focusing function, such that the wavelength range of light incident on the nanostructure layer is reduced to a predefined wavelength range and light emitted from the nanostructure is focused on the photo-detection layer.

According to a second aspect, the disclosure provides a time-of-flight system, comprising a light source; and a time-of-flight device, including a photo-detection layer, and a nanostructure layer arranged on the photo-detection layer, wherein the nanostructure layer has a wavelength filtering function and a focusing function, such that the wavelength range of light incident on the nanostructure layer is reduced to a predefined wavelength range and light emitted from the nanostructure is focused on the photo-detection layer.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 illustrates an example of a time-of-flight device;

FIG. 2 schematically illustrates a nanostructure layer arranged on a photo-detection layer according to an embodiment of a time-of-flight device;

FIG. 3 schematically illustrates an optical stack including only a nanostructure layer arranged on a photo-detection layer according to an embodiment of a time-of-flight device;

FIG. 4 schematically illustrates an optical stack including an electrically tunable principal lens and a nanostructure layer arranged on a photo-detection layer according to an embodiment of a time-of-flight device;

FIG. 5 schematically illustrates an embodiment of a time-of-flight device wherein a nanostructure layer is electrically tunable to obtain a predefined wavelength range and/or a predefined field of view and viewing angle;

FIG. 6 schematically illustrates an embodiment of a time-of-flight device wherein a nanostructure layer includes at least one nanostructure having a spiral-like shape;

FIG. 7 schematically illustrates a side view of a nanostructure having a spiral-like shape, of the time of flight device of FIG. 6;

FIG. 8 schematically illustrates an embodiment of a time-of-flight device wherein a nanostructure layer has a conical-like shape;

FIG. 9 schematically illustrates a side view of a nanostructure having a conical-like shape, of the time of flight device of FIG. 8;

FIG. 10 schematically illustrates another embodiment of a time-of-flight device wherein a nanostructure layer includes at least one nanostructure having a conical-like shape;

FIG. 11 schematically illustrates a side view of a nanostructure having a conical-like shape, of the time of flight device of FIG. 10;

FIG. 12 schematically illustrates an embodiment of a time-of-flight device wherein a nanostructure layer has a spherical-like shape;

FIG. 13 schematically illustrates a side view of a nanostructure having a spherical-like shape, of the time of flight device of FIG. 12;

FIG. 14 schematically illustrates an example of a time-of-flight system; and

FIG. 15 is a flowchart of an embodiment of a method for providing a time-of-flight device.

### DETAILED DESCRIPTION OF EMBODIMENTS

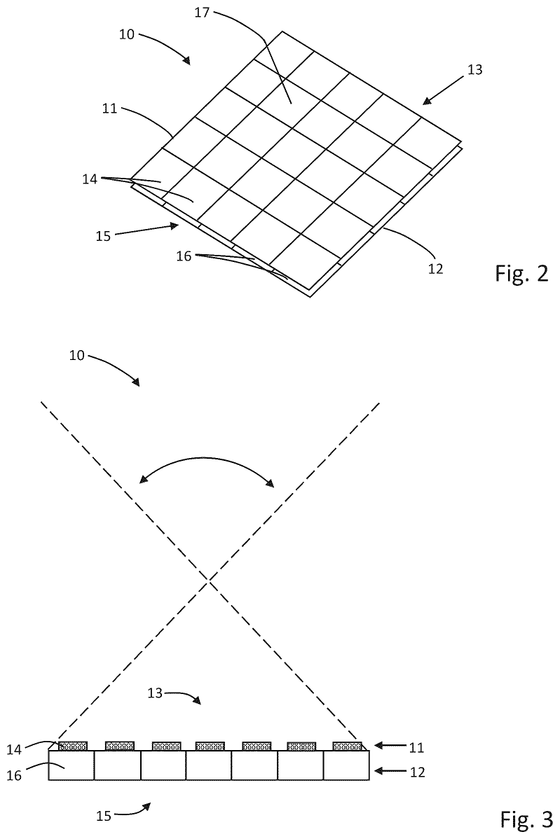

Before a detailed description of the embodiments under reference of FIG. 2, general explanations are made.

As mentioned in the outset, time-of-flight systems may have a light source for illuminating a region of interest and a camera for detecting light stemming from the region of interest for determining a distance between the light source and the region of interest. In some embodiments, the distance can be determined, based on a phase shift of the light introduced when traveling from the light source to the camera, which, in turn, is associated with the distance, while in other embodiments the distance is determined based on a roundtrip time of the light when traveling from the light source to the camera.

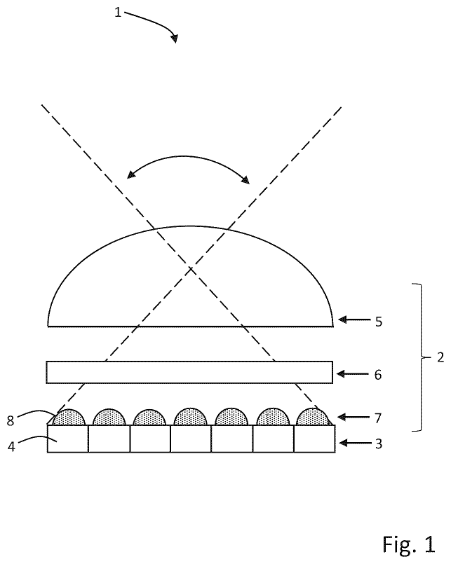

For detection of light in the time-of-flight technology, it is known to use image sensors having multiple pixels, wherein in some cases on each pixel a micro lens is arranged for focusing light onto the pixel. FIG. 1 exemplary illustrates such a time-of-flight (ToF) device 1. The ToF has an optical stack 2 arranged on (above in FIG. 1) a photo-detection pixel array 3 with multiple photo-detection pixels 4, which is based on common principles, such as CCD (charge couple device) technology, CMOS (complementary metal oxide semiconductor) technology, SPADs (single-photon avalanche diodes) technology or the like. The optical stack 2 has, in the order of incident light, a principal lens 5, an optical filter 6 and a micro lens array 7, wherein the micro lens array 7 is directly arranged on the pixel array 3. The micro lens array 7 has multiple micro lenses 8, wherein for each photo-detection pixel 4 an associated lens 8 is provided for focusing incident light onto the corresponding pixel 4.

The optical stack 2 has a focusing function and wavelength filtering function: The principal lens 5 focuses the transmitted light to the micro lens array 7, which in turn focuses the light to the a convenient position (e.g. center) of corresponding photo-detection pixels 4, wherein the optical filter 6, which is arranged between the principal lens 5 and the micro lens array 7, filters or reduces the wavelength of the light to predetermined wavelength range (e.g. infrared or near infrared). Typically, the principal lens 5 together with the light sensitive area of the ToF device 1 predetermine the Field-of-View (FoV) of the ToF device 1.

In some instance, such a ToF device (which can also be a single pixel array), the micro-lenses on the top of each pixel provide an improved the fill factor, e.g. compared to known devices which do not implement micro-lenses. The micro-lenses may center the illumination to each corresponding pixel, which may avoid cross-talk between pixels due to scattered or non-properly focused light, and may reduce tap mismatch when determining a distance based on the detected incoming or incident light.

The position of the micro-lenses on the top of each pixel may depend on the optical profile of the principal lens, i.e. it may depend on how the main lens focusses the light to the pixel array 3. Hence, each micro-lens should be positioned or aligned correctly on top of the corresponding pixel, which may be challenging for mass production.

Moreover, the optical elements of the optical stack 2, e.g. lenses 4, and 5 and the optical filter 6, may scatter the light on the way to the pixel array 3, which, in turn, may affect ToF (distance) measurements, e.g. light may be scattered between the different surfaces of the optical elements and may also be scattered to multiple pixels 4.

Furthermore, known narrow-band filters typically also influence the width of the field of view.

In view of the above, it has been recognized that nanostructures, such as nano-antennas, nano-wires, nano-rods, nano-spheres, three-dimensional nano-structure (e.g. nano-tubes, or other three dimensional structures which may be formed on the basis of graphite) or the like, which are known for nanophotonic applications, can be applied to ToF devices in some embodiments.

Thus, some embodiments pertain to a time-of-flight (ToF) device having a photo-detection layer and a nanostructure layer arranged on the photo-detection layer. The nanostructure layer has a wavelength filtering function and a focusing function, such that the wavelength range of light incident on the nanostructure layer is reduced to a predefined wavelength range and light emitted from the nanostructure is focused on the photo-detection layer.

The ToF device may be formed based on a semiconductor and may be in any manufacturing stage, such as on a wafer level, stacked semiconductor layers, may be in the form of or part of an electronic device including a housing or the like.

The ToF device may be arranged for time-of-flight measurement and may also include corresponding circuitry for reading out and/or analyzing signals produced by the photo-detection layer and it might be adapted for applying signals to the nanostructure layer and/or for read out of signals provided by the nanostructure layer.

The photo-detection layer has the function of detecting the incident light, which, for example, is scattered by a region of interest, which may be illuminated by a light source, as it is generally known for time-of-flight technology.

The photo-detection layer may include at least one photo-sensitive area which is configured to detect the incident light and it may be based on the known CMOS (Complementary Metal-Oxide-Semiconductor) technology, CCD (Charge Coupled Device) technology, SPAD (Single Photon Avalanche Diode) technology or the like.

Typically, the photo-detection layer may output photo-detection signal upon detection of incident light for further processing, e.g. by the circuitry mentioned above. The photo-detection layer may also include circuitry and/or transistors for at least pre-processing the photo-detection signals including analogue-to-digital conversion, light phase shift detection or the like.

The nanostructure layer is arranged on the photo-detection layer such that light incidents onto the nanostructure layer before it reaches the photo-detection layer, wherein the nanostructure layer may be directly arranged on the photo-detection layer, such that no further layers are arranged between the nanostructure layer and the photo-detection layer, wherein in other instances, further layers may be arranged between the nanostructure layer and the photo-detection layer, such as one or more dielectric layers, e.g. for electric insulation between the nanostructure layer and the phot-detection layer. The nanostructure layer may be pre-manufacture on a (transparent) substrate or the like and may be bonded to the photo-detection layer or may be attached to it with another technology, such as adhering or the like. But, the nanostructure layer may also be formed on the photo-detection layer after or during manufacturing of the photo-detection layer. The manufacturing of the nanostructure layer may also be based on the (mentioned above) technology principles of the underlying photo-detection layer, e.g. such as it is the case for the CMOS, CCD or other common technology. Nanostructures may also be deposited on a wafer, e.g. on substrate or directly on the photo-detection layer (or another layer on the photo-detection layer) and/or they may be formed based on a metallization process at is known per se.

As mentioned, the nanostructure layer has a wavelength filtering function and a focusing function, such that the wavelength range of light incident on the nanostructure layer is reduced to a predefined wavelength range and light emitted from the nanostructure is focused on the photo-detection layer. As will also be discussed further below, in some embodiments the nanostructure layer (nanostructures) have further functions, such as the function of an optical lens, the function of creating and/or changing a field of view (including an angle of field of view), etc. Hence, in some embodiments, the functions are also combined (all together or partly), and, for example, the nanostructure layer (the nanostructures) provides the optical effects (functions): main optical lens function, focal point position, width of the field of view, angle of the field of view, optical filter, pixel focus, etc.

The nanostructure layer includes at least one (typically multiple) nanostructure, wherein each of the multiple nanostructures may have the wavelength filtering function and a focusing function. Each nanostructure (or a group of nanostructures) may focus light onto a photo-sensitive area of the photo-detection layer.

The nanostructures may transmit incident light, whereas the nanostructures may also receive incident light and (actively) emit light, which may be wavelength filtered and focused to the photo-sensitive area. The predefined wavelength range may be chosen for the specific need in some embodiments, and it may be an infrared (e.g. from 1 mm to 780 nm) or near infrared range (e.g. from 780 nm to 1400 nm) as typically used in some ToF applications.

Hence, as the nanostructure layer has the wavelength filtering function, in some embodiments, a narrow-band optical filter(s) is not needed and, thus, the limitation of narrow-band filters may be avoided, although wide-band optical filters may still be provided in some embodiments.

As the nanostructure layer has the focusing effect, the complexity of the alignment of the micro-lenses with respect to a profile of main (principle) lens may be removed in some embodiments and, moreover, alignment of the micro-lenses with respect to pixels or the like of the photo-detection layer may be avoided.

A nanostructure (or a group of nanostructures) may focus light in a small spot, such that it acts similarly as a micro-lens, but it may have even an increased focusing effect compared to typical micro-lenses and, as nanostructure may be smaller in the height and/or lateral extension than micro-lenses a fill factor of the ToF device may be improved compared to cases where micro-lenses are used.

Nanostructures may be formed by using a metal (or multiple metals, e.g. a mixture (e.g. alloy) with good plasmonic effects and, e.g., also in combination with semiconductor materials and/or dielectrics, wherein such materials may be common in the chip industry. Nanostructures may also be formed by using plasmonic meta-materials, e.g. gold, silver, aluminum, quantum-dots, metallic alloys or the like. Moreover, nanostructures may be formed by using other materials, which have metal-like behavior and optical properties in the specific wavelength range (for example, 800 nm to 1870 nm), such as e.g. Transparent Conducting Oxides, dielectric materials, such as silicon, Germanium, graphene, and the like. Furthermore, two-dimensional (2D) and three-dimensional (3D) materials may be used to form nanostructures, such as e.g. graphene nano-tube, graphene balls, graphene layered shapes and the like. Nanostructures may have a located surface plasmon resonance (LSPR) or plasmon, which provides the focusing and/or wavelength reducing effect.

Additionally in some embodiments, even the optical stack, such as optical stack 2 of FIG. 1, which introduces scattering, may be omitted or at least one or more of the optical elements of the optical stack (main lenses, optical filters, micro-lenses, etc.) may be omitted to providing the nanostructure layer including nanostructure(s).

In some embodiments, the nanostructure layer includes a nanostructure array including multiple nanostructure areas. Each nanostructure area may include at least one nanostructure or a group of nanostructures and each nanostructure area may be aligned with an associated photo-detection area, such that light is focused by a nanostructure area to an associated photo-detection area, e.g. in the center of the associated photo-detection area. The nanostructure array may be a portion of the nanostructure layer and it may have a regular spacing in a width and a length direction of the nanostructure layer. The nanostructure areas of the nanostructure array may have a circular, elliptical, rectangular, quadric, triangular or any other cross-sectional shape and/or the nanostructure area may be defined by a structural limitation and/or only by a (regular) predefined spacing of the corresponding nanostructures included in the nanostructure areas.

In some embodiments, the photo-detection layer includes a photo-detection array including multiple photo-detection pixels, wherein a photo-detection pixel may be an element, which converts light into an electric charge which is processed, e.g. by an integrated circuitry, into an electronic (analog or digital) signal. The pixels may have any type of cross-sectional shape, such as circular, elliptical, rectangular, quadratic, etc., as also explained for the nanostructure array areas. The pixel may have the same size and have a predefined spacing to each other (or are adjacent to each other) as it is generally known for pixel array detectors.

In some embodiments, as mentioned, the nanostructure layer may include a nanostructure array including multiple nanostructure areas and the photo-detection layer may include a photo-detection array including multiple photo-detection pixels, wherein each nanostructure area of the multiple nanostructure areas is centrically aligned with an associated photo-detection pixel of the multiple photo-detection pixels. Hence, a perpendicular and centric axis of each of the nanostructure array areas may be coincident with a perpendicular and centric axis of an associated pixel. Moreover, each of the nanostructure array areas may focus the light centrically to the underlying and associated pixel, (e.g. the light is focused in a specific spot inside each pixel, which may avoid undesirable effects, such as crosstalk or the like). In some embodiments, the alignment and positioning of the nanostructure array (areas) to the pixel array is easier controllable compared to cases where a micro-lens array is implemented.

In such embodiments, each of the multiple nanostructure areas may have the wavelength filtering function and the focusing function, such that the wavelength range of light incident on each of the multiple nanostructure areas is reduced to a predefined wavelength range and light emitted from each of the multiple nanostructure areas is focused on the associated photo-detection pixel of the multiple photo-detection pixels.

In some embodiments, the nanostructure layer is electrically tunable to a predefined wavelength range. The nanostructures of the nanostructure layer may change their susceptibility upon application of an electric voltage and/or they may change their transmittance characteristics and, thus, the range of filtered wavelength may be adapted or tuned accordingly.

In some embodiments, the nanostructure layer is adapted for application of a phase control signal, wherein by application of the phase control signal a position of an optical axis and/or a field-of-view of the nanostructure layer may be adjustable. The nanostructure layer may include at least one terminal for the application of the phase control signal. In some embodiments, where a nanostructure array is provided, for instance, each row and/or each column of the nanostructure array may have a common terminal for application of the phase control signal.

In some embodiments, the nanostructure layer is formed based on at least one of: nano-wires, nano-rods, nano-spheres, three dimensional (3D) nano-structure, nano-antennas, wherein nano-wires may be wires having dimensions in the nanometer range, nano-rods may be rods having dimensions in the nanometer range, nano-spheres may be spheres having a diameter in the nanometer range and nano-antennas may be antennas having an antenna-like structure in the nanometer range and having an optical antenna function, wherein nanometer range may also cover dimension which are much smaller (one or more order) than a nanometer or may be larger than a nanometer up to at least one order (or more). As mentioned, the nanostructure layer may include multiple nanostructures, wherein one nanostructure may correspond to one nano-wire, nano-rod, nano-sphere, 3D nanostructure, nano-antenna or to a group of nano-wires, nano-rods, nano-spheres, nano-antennas and/or a mixture of single nano-wires, nano-rods, nano-spheres, 3D nanostructure, nano-antennas and/or groups of single nano-wires, nano-rods, nano-spheres, 3D nano-structure, nano-antennas. In some embodiments, also a nano-wire, nano-rod, nano-sphere or the like may have the function of a (optical) nano-antenna.

As mentioned, in some embodiments, the nanostructure has a (optical) nano-antenna like function and are also referred to as nano-antennas, which are also known per se. A nano-antenna may be designed to have a narrow band-pass wavelength filtering function (e.g. to infrared or near-infrared) and a nano-antenna may be tunable, so it is possible, in some embodiments, to design different field of views, different focal points, and also to implement a scanning feature based on controlling the nano-antennas accordingly, which are, e.g., arranged in a nanostructure array.

In some embodiments, the nanostructure layer includes at least one of: carbon, metal, semiconductor, dielectric, such that, for example, the nanostructures are made of at least one of these materials. For metal gold is prominent example which is used for forming nanostructures, without limiting the present disclosure in that regard and other metals can be used, such as silver.

In some embodiments, the nanostructure layer includes at least one nanostructure having a spiral-like shape, wherein the at least one nanostructure is adapted to focus the emitted light in the center of a photo-detection area of the photo-detection layer, as also indicated above. The spiral shape may be closed or open and it may be based on a circular, elliptic, rectangular, quadratic or other suitable basic form. As discussed above, in some embodiments a phase control signal is applied to the nanostructure layer and in the case of a spiral shape a terminal of the spiral can be used as a terminal for application of the phase control signal. Moreover, in the case of a nanostructure array, each nanostructure area may include one spiral form, wherein, for example, nanostructure spirals of one row (or of one column) may be at least partially interconnected to each other.

In some embodiments, the nanostructure layer includes at least one nanostructure forms a conical-like shape, wherein the at least one nanostructure is adapted to focus the emitted light in the center of the photo-detection area of a photo-detection layer. The conical-like shape may be formed based on a continuous nanostructure or it may be based on a grouping of different nanostructure elements (e.g. spheres) together in a way that a conical-like shape is provided. In some embodiments, the mentioned conical-like shape is substituted by or mixed with cylindrical-like shapes (as nano-rods or nano-wires or the like 3D structures).

In such embodiments, the nanostructure may be formed by a first type of nanostructure elements and by a second type of nanostructure elements, wherein the first type of nanostructure elements are arranged in a first layer and the second type of nanostructure elements are arranged in a second layer, the first and second layer being arranged on top of each other. The first type of nanostructure elements and the second type of nanostructure elements may have the same or a different shape and they may be based on the same material or on different materials. In some embodiments, the conical-like shape refers to a region “negatively” formed by the first type and second type of nanostructure elements, such that, e.g., an inner region which is surrounded by the first type and second type of nanostructure elements has the conical-like shape, wherein the conical-like shape may not be formed with the material used for the first and second type of nanostructure elements, while in other embodiments the conical-like shape is “positively” formed by the first type and second type of nanostructure elements, such that the conical-like shape is formed with the material which is used for the first type and second type of nanostructure elements, respectively. The cross-sectional shape of the conical-like structure may be circular, but it can have any type of shape, such as elliptical, rectangular, quadratic, star-like, etc.

In such embodiments, a dielectric layer may be arranged between the first layer and the second layer, such that, for example, as mentioned, the conical-like shape may be at least partially formed by the dielectric material of the dielectric layer.

In some embodiments, the nanostructure layer includes at least one nanostructure having a spherical shape, wherein the nanostructure layer may include at least two types of spheres, wherein the diameter of the first type of spheres is larger than the diameter of the second type of spheres. The first type of spheres may (at least partially) surrounds the second type of spheres, which may enhance a focusing effect of the thereby formed nanostructure. Each sphere of the second type of spheres may be surrounded by at least three spheres (e.g. four spheres) of the first type of spheres for focusing the emitted light. The nanostructure layer may include a first layer and a second layer, wherein the spheres of the first type are arranged in the first layer and wherein the spheres of the second type are arranged in the second layer, wherein the first and the second layer are arranged on top of each other. The spheres of the first layer may engage into the second layer (and/or vice versa).

Some embodiments pertain to a time-of-flight system, including a light source; and a time-of-flight device, as described herein, e.g. including a photo-detection layer, and a nanostructure layer arranged on the photo-detection layer, wherein the nanostructure layer has a wavelength filtering function and a focusing function, such that the wavelength range of light incident on the nanostructure layer is reduced to a predefined wavelength range and light emitted from the nanostructure is focused on the photo-detection layer.

The light source may be a pulsed light source or a continuous light source and it may be based on LEDs (Light Emitting Diodes), laser elements, e.g. VCSELs (Vertical Cavity Surface Emitting Lasers) or the like.

Moreover, the ToF system may include circuitry for processing and analyzing the detection signals generated by the ToF device and it may be configured to control the ToF device accordingly and as it is described herein. The ToF system may provide a distance measurement, may scan a region of interest and may provide depth maps/images or the like from the region of interest.

The ToF device or system may be used in different technology applications, such as in Automotive, Gaming applications (e.g. gesture detection), as well as in smart phones or other electronic devices, such as computers, laptops, or in medical device, etc. The ToF device or system may have an image sensor size in the order of 100 nm to 10 nm, without limiting the present disclosure in that regard.

Returning to FIGS. 2 and 3, an embodiment of a Time-of-Flight (ToF) device 10 is illustrated, wherein FIG. 2 illustrates a top view of the ToF device 10 and FIG. 3 illustrates a side view of the ToF device 10.

The ToF device 10 has a nanostructure layer 11 and a photo-detection layer 12.

The nanostructure layer 11, which is arranged on top of the photo-detection layer 12, has a nanostructure array 13, wherein the nanostructure array 13 is divided into multiple nanostructure areas 14, which are arranged in rows and columns as it is typically known for arrays.

The photo-detection layer 12 has a pixel array 15, which is divided into multiple pixels 16 arranged in columns and rows of an array (as known per se), wherein each of the pixels is configured to generate an electric charge or signal upon detection of incoming light.

Each of the multiple nanostructure areas 14 has at least one nano-antenna, as described herein and as will be also explained in the following, wherein the nano-antenna is formed based on nano-wires (not shown) made of gold, which has the focusing and wavelength filtering function as explained herein. Hence, each of the nanostructure areas 14 focuses and filters light which incidents from top within a field of view (dashed lines in FIG. 3) onto the nanostructure layer 11.

Each of the nanostructure areas 14 is centrically aligned (see also FIG. 3) with the underlying associated pixel 16 of the photo-detection layer 12, such that a central and perpendicular axis 17 (FIG. 2) of each of the nanostructure areas 14 and the associated pixel 16 are coincident and each of the nanostructure areas 14 focuses the light to the associated pixel 16 to a centralized spot in the associated pixel 16.

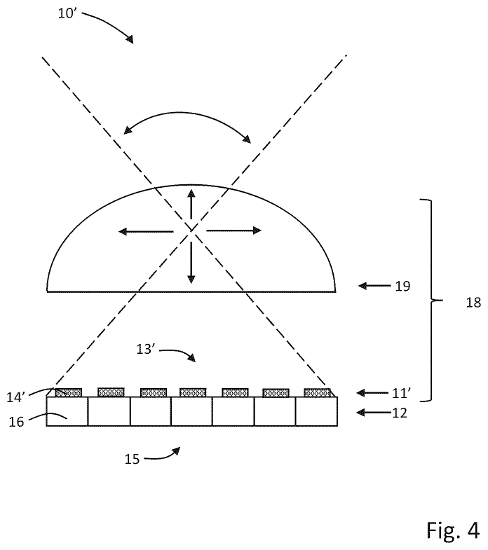

In some embodiments, as will discussed under reference of FIGS. 4 to 6 in the following, a ToF device generally has an optical stack arranged on a photo-detection pixel layer (as discussed under reference of FIGS. 2 and 3), wherein the optical stack may (only) include a nanostructure array (without limiting the present disclosure to ToF devices having an optical stack) and additional optical elements. In the following, embodiments having different optical stacks and different nanostructures will be discussed.

FIG. 4 illustrates, in a side view, basically the embodiment of FIGS. 2 and 3, wherein the ToF device 10′ of FIG. 4 has an optical stack 18, which includes the nanostructure layer 11′ arranged on the photo-detection layer 12 and additionally a principal lens 19.

The photo-detection layer 12 and the principal setup of the nanostructure layer 11′ correspond to the photo-detection layer 12 and the nanostructure layer 11 of the embodiment of FIGS. 2 and 3 and it is referred to the associated description above in that regard.

The principal lens 19 focuses incident light to the nanostructure layer 11′ and the nanostructure areas 14′ of the nanostructure array 13′ further focus and filter the light to an associated pixel 16, as discussed above. Moreover, the principal lens 19 is electrically tunable, e.g. in any direction (left or right or up or down in FIG. 4 or also perpendicular to the plane of the Fig.).

While the nanostructure layer 11 of the ToF device 10 of FIGS. 2 and 3 took over the function of a principal lens, the nanostructure layer 11′ of the ToF device 10′ of the present embodiment does not have the function of the principal lens, but the principal lens 19 focuses the light accordingly to the nanostructure layer 11′.

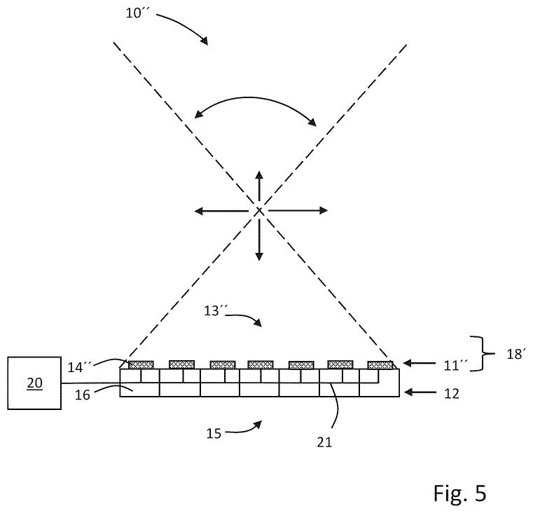

FIG. 5 illustrates, in a side view, an embodiment which basically corresponds to the embodiment of FIG. 4, wherein the ToF device 10″ of FIG. 5 of the present embodiment has an optical stack 18′, which does not include the principal lens 19 as it is the case for the ToF device 10′ of FIG. 4, but a nanostructure layer 11″ arranged on the photo-detection layer 12 takes over the functionality of the tunable principal lens 19 of the embodiment of FIG. 4.

The photo-detection layer 12 and the principal setup of the nanostructure layer 11″ correspond to the photo-detection layer 12 and the nanostructure layer 11 of the embodiment of FIGS. 2 and 3 and it is referred to the associated description in that regard.

The nanostructure layer 11″ is adapted for application of a phase control signal provided by a phase control 20. The nanostructure layer 11″ includes a wiring 21 for the application of the phase control signal, wherein in the present embodiment the wiring 21 has for each row of the nanostructure array 13″ a common terminal for the application of the phase control signal provided by the phase control 20.

By application of the phase control signal, a position of an optical axis and/or an angle of the field of view and/or a field-of-view of the nanostructure layer 11″ is adjustable.

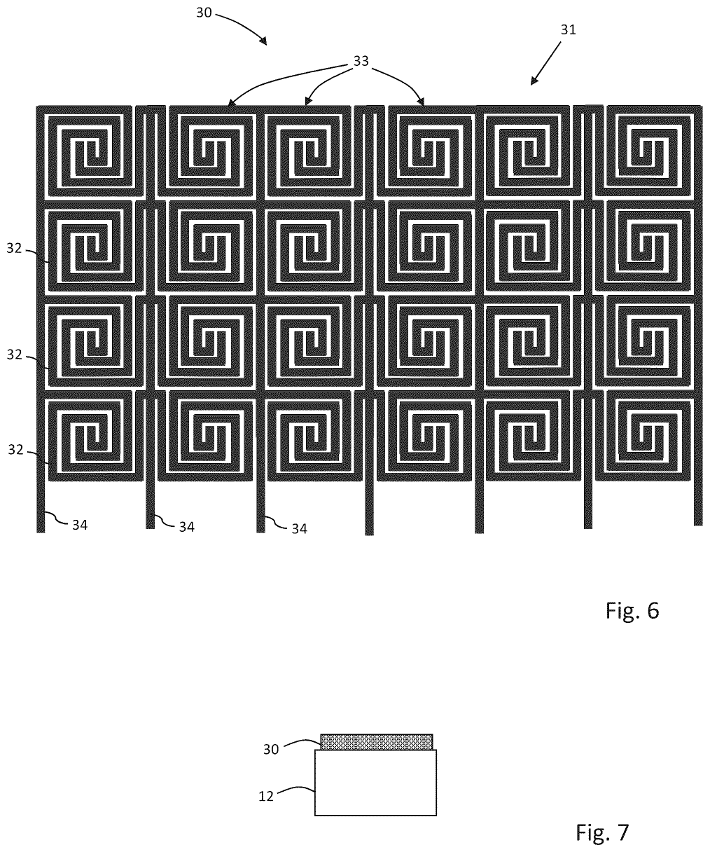

In the following, different embodiments of different nanostructures will be explained under reference of FIGS. 6 to 11, wherein each of the nanostructure layers discussed in the following may have one or more terminals (e.g. also for rows or columns) for application of a phase control signal.

An embodiment of nanostructure layer 30 with a nanostructure array 31 including nanostructures 32 having a spiral-like shape is illustrated in FIG. 6 in a top view and in FIG. 7 in a side view, wherein the nanostructure layer 30 is arranged on a photo-detection layer 12, such as the photo-detection layer of FIGS. 2 and 3.

The nanostructure array 31 is exemplary divided in four rows and six columns of nanostructure areas 33, wherein each nanostructure area 33 has one nanostructure 32 with a spiral-like shape, which is adapted to focus the emitted light in the center of a pixel of the photo-detection layer 12.

The spiral shapes are open in the middle and have a rectangular circumference and windings and are such arranged that they are connected to each other. Each one of the nanostructure areas 33 occupies an associated ToF photo-detection pixel of the photo-detection layer 12.

Each row of the nanostructure layer 30 has a terminal 34 for application of a phase control signal, e.g. provided a phase control 20 as discussed for the embodiment of FIG. 5.

The spiral-like nanostructures are formed with gold in a metallization process as discussed above.

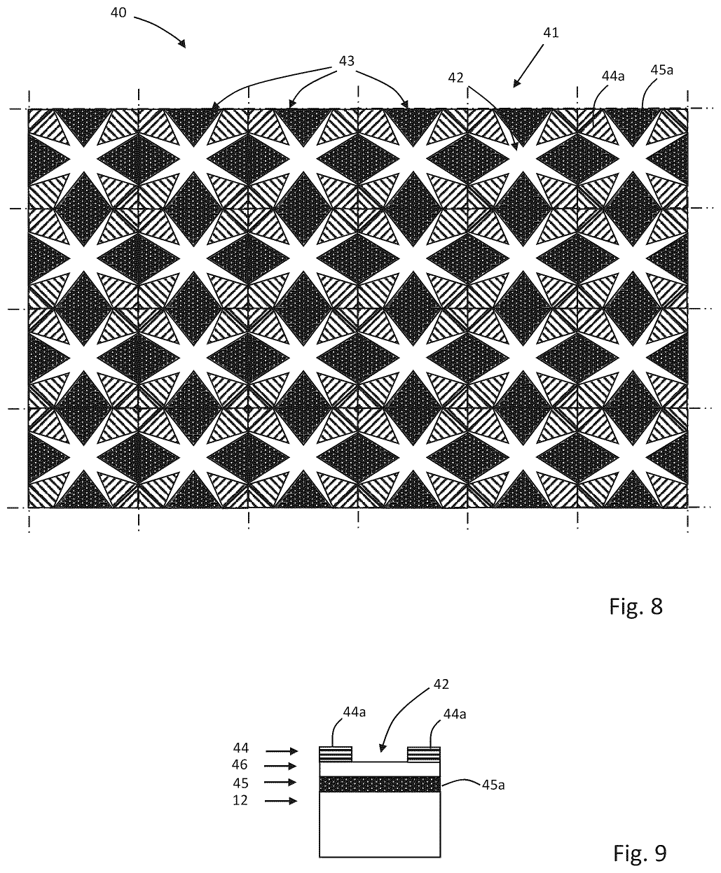

An embodiment of a nanostructure layer 40 with a nanostructure array 41 including nanostructures 42 having a conical-like shape is illustrated in FIG. 8 in a top view and in FIG. 9 in a side view, wherein the nanostructure layer 40 is arranged on a photo-detection layer 12, such as the photo-detection layer of FIGS. 2 and 3.

The nanostructure array 41 has exemplary six columns and four rows with nanostructure areas 43 each occupying a ToF photo-detection pixel of the photo-detection layer 12.

Each nanostructure area 43 has one nanostructure 42, which has a conical-like shape, which is formed on the basis of several nanostructure elements, which are arranged in different layers.

In a top layer 44 (FIG. 9), a first type of nanostructure elements 44a is arranged, which each have a triangular cross section. The first type of nanostructure elements 44a is such arranged, that an edge of each nanostructure elements 44a is directed towards a center point around which four nanostructure elements 44a are arranged within each nanostructure area 43.

In a bottom layer 45 (FIG. 9), which is next to the photo-detection layer 12, a second type of nanostructure elements 45a is arranged, which each have a triangular cross section. The second type of nanostructure elements 45a is such arranged, that an edge of each nanostructure elements 45a is directed towards a center point around which four nanostructure elements 45a are arranged within each nanostructure area 43.

Between the top layer 44 and the bottom layer 45, a dielectric layer 46 is arranged.

In a top view (FIG. 8), although being in different layers, the first type of nanostructure elements 44a and the second type of nanostructure elements 45a are such arranged, that they alternate each other, i.e. a first type of nanostructure element 44a is followed by a second type of nanostructure element 45a, etc., wherein the first type of nanostructure elements 44a and the second type of nanostructure elements 45a are such arranged that their edges point to the same central axis in the middle of the elements 44a and 45a. Thereby, in a top view (FIG. 8), a star like shape is formed in the middle of the elements 44a and 45a, which is filled with the dielectric material of the dielectric layer 46.

Thereby, the conical-like shape is formed which focuses the emitted light in the center of the photo-detection pixels (and filters the light accordingly).

The nanostructure elements 44a and 45a are made of gold and they are formed with a metallization process.

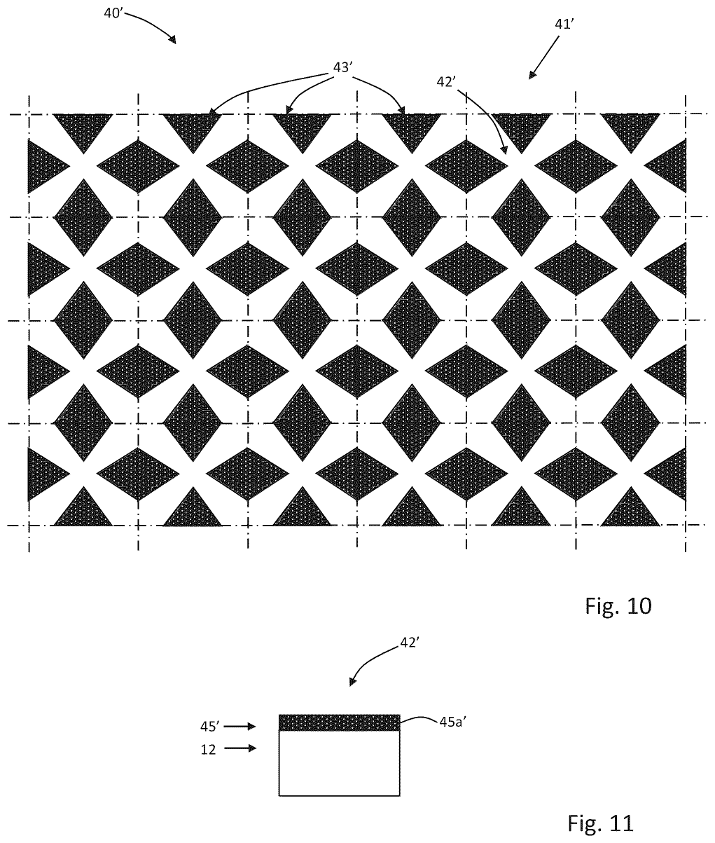

An embodiment of a nanostructure layer 40′ with a nanostructure array 41′ including nanostructures 42′ having a conical-like shape is illustrated in FIG. 10 in a top view and in FIG. 11 in a side view, wherein the nanostructure layer 40′ is arranged on a photo-detection layer 12, such as the photo-detection layer of FIGS. 2 and 3.

The embodiment is a simplified version of the embodiment illustrated in FIG. 8 (top view) and FIG. 9 (side view). The nanostructure array 41′ has exemplary six columns and four rows with nanostructure areas 43′ each occupying a ToF photo-detection pixel of the photo-detection layer 12, such as the nanostructure array of FIG. 8.

Each nanostructure area 43′ has one nanostructure 42′, which has a conical-like shape, which is formed on the basis of several nanostructure elements.

In layer 45′ (FIG. 11), which is next to the photo-detection layer 12, one type of nanostructure elements 45a′ is arranged, wherein each of the nanostructure elements 45a′ have a triangular cross section. The nanostructure elements 45a′ are such arranged, that an edge of each nanostructure elements 45a′ is directed towards a center point around which four nanostructure elements 45a′ are arranged within each nanostructure area 43′ (similarly as the nanostructure elements of FIGS. 8 and 9).

As can be taken from the top view of FIG. 10, the nanostructure elements 45a′ are such arranged that their edges point to the same central axis in the middle of the elements 45a′. Thereby, in a top view (FIG. 10), a “X” like shape is formed in the middle of the elements 45a′, which is filled with the dielectric material of the dielectric layer 46 (in some embodiments).

Thereby, the conical-like shape is formed which focuses the emitted light in the center of the photo-detection pixels (and filters the light accordingly).

An embodiment of nanostructure layer 50 with a nanostructure array 51 including nanostructures 52 having a sphere-like shape is illustrated in FIG. 10 in a top view and in FIG. 11 in a side view, wherein the nanostructure layer 50 is arranged on a photo-detection layer 12, such as the photo-detection layer of FIGS. 2 and 3.

The nanostructure array 51 has five columns and four rows of nanostructure areas 53, wherein each nanostructure area 53 occupies a ToF photo-detection pixel of the photo-detection layer 12.

In each nanostructure area 53 small nano-spheres 54 are arranged in the center of the associated area 53, wherein the small nano-spheres 54 are arranged in a top layer 55.

The small nano-spheres 54 are surrounded by large nano-spheres 56, which are arranged in a bottom layer 57, which is next to the photo-detection layer 12. In the present embodiment, each small nano-sphere 54 is surrounded by four large nano-spheres 56, wherein the large nano-spheres 56 are arranged at the corners of the quadratic nanostructure areas 53, such that the center axis of each large nano-sphere 56 coincidences with one of the corners of the associated nanostructure area 53.

The diameter of the small nano-spheres 54 is smaller than the diameter of the large nano-spheres 56.

The large nano-spheres 56 have a diameter which is larger than the height of the bottom layer 57, such that they engage into the top layer 55. Furthermore, the large nano-spheres 56 are embedded in a dielectric material on the basis of which the bottom layer 57 is formed.

The nano-spheres 54 and 56 are made of gold and are formed in a metallization process.

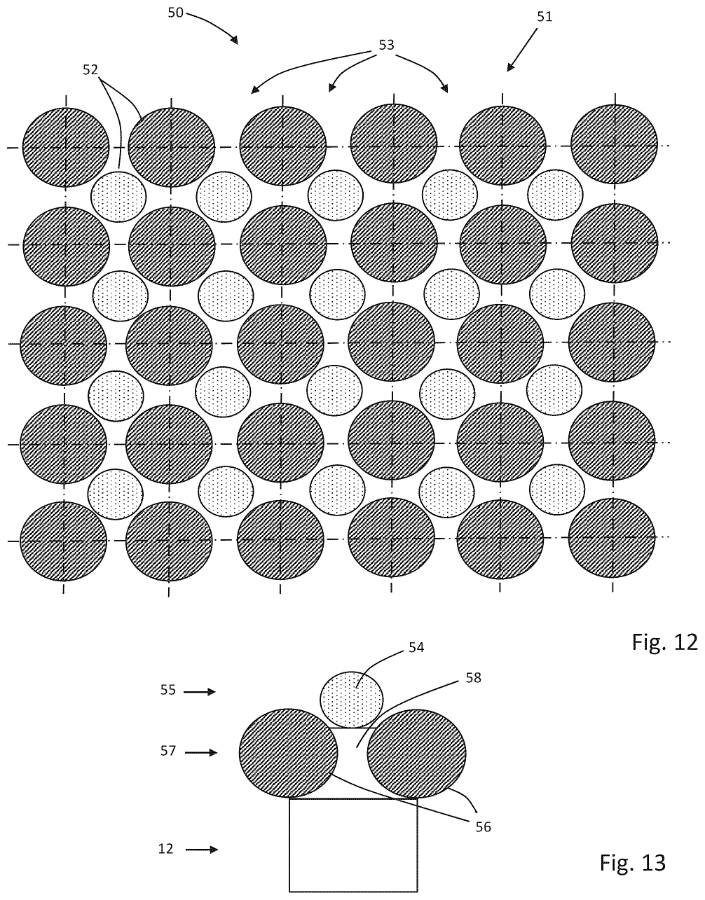

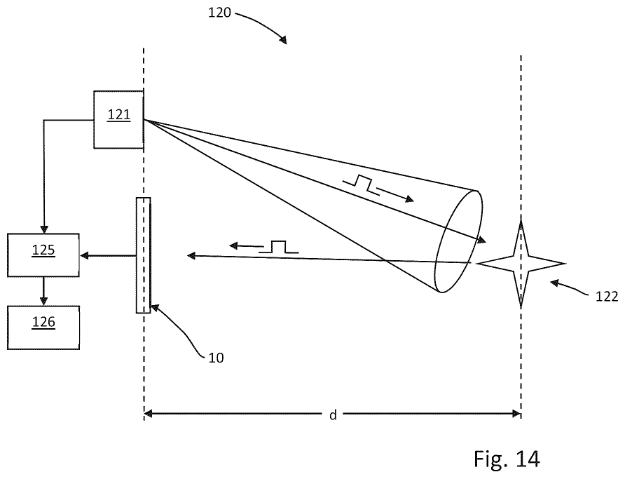

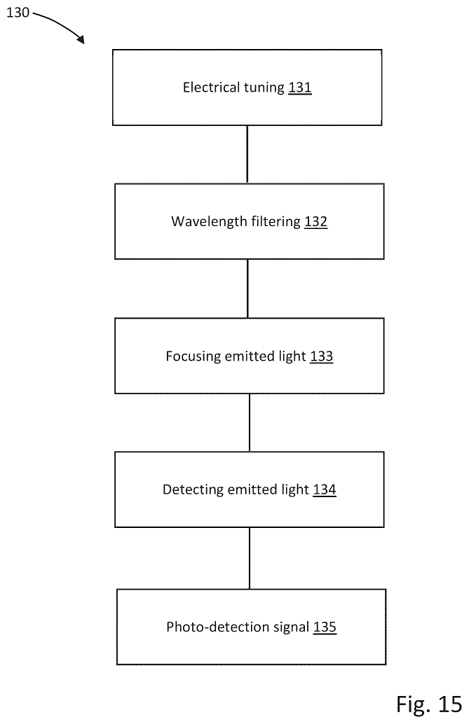

FIG. 12 generally illustrates a time-of-flight depth sensing system 120. The system 120 has a pulsed light source 121, which can be any kind of light source suitable for time-of-flight depth sensing and it includes, for example, light emitting elements (based on laser diodes, or the like). The system 120 includes the time-of-flight device 10 as discussed above under reference of FIGS. 2 and 3, without limiting the present disclosure in that regard, and it can include any embodiment of a ToF device as discussed herein.

The light source 121 emits pulsed light to an object 122, which reflects the light. By repeatedly emitting light to the object 122, the object 122 can be scanned, as it is generally known to the skilled person. The reflected light is detected by the ToF device 10, as discussed herein.

The light emission time information is fed from the light source 121 to a time-of-flight measurement unit 125, which also receives respective time information from the ToF device 10, when the light is detected which is reflected from the object 122. On the basis of the emission time information received from the light source 121 and the time of arrival information received from the ToF device 10, the time-of-flight measurement unit 125 computes a round-trip time of the light emitted from the light source 121 and reflected by the object 122 and on the basis thereon it computes a distance d (depth information) between the ToF device 10 and the object 122.

The depth information is fed from the time-of-flight measurement unit 125 to a 3D image reconstruction unit 126, which reconstructs (generates) a 3D image of the object 122 based on the depth information received from the time-of-flight measurement unit 125.

FIG. 13 is a flowchart of an embodiment of a method 130 for providing the functionality of a ToF device, such as anyone of the ToF devices discussed herein. In the following, the method 130 is discussed based on the functions the ToF device 10 of FIGS. 2 and 3 without limiting the present disclosure in that regard. Generally, the method 130 may be used for controlling the ToF device, as discussed herein.

At 131, the nanostructure layer 11 is tuned upon receipt of a phase control signal, as discussed herein, for tuning the focusing and filtering characteristic.

At 132, the nanostructure layer 11 filters the wavelength of the incident light, such that the wavelength range of light incident on the nanostructure layer is reduced to a predefined wavelength range. Hence, the nanostructure filters or reduces the wavelength of the light to predetermined wavelength range, such as infrared or near infrared.

At 133, the nanostructure layer 11 focuses the emitted light on the photo-detection layer 12.

At 134, the photo-detection layer 12 detects the emitted light from the nanostructure layer 11, which, for example, is scattered by a region of interest which may be illuminated by a light source, as it is generally known for time-of-flight technology, and as it is indicated in the discussion of FIG. 12 above.

At 135, the photo-detection layer 12 outputs a photo-detection signal, which can be further processed.

In some embodiments, the method 130 is performed automatically based on a general-purpose computer or the like.

The methods as described herein, in particular method 130, are also implemented in some embodiments as a computer program causing a computer and/or processor and/or circuitry to perform the method, when being carried out on the computer and/or processor and/or circuitry. In some embodiments, also a non-transitory computer-readable recording medium is provided that stores therein a computer program product, which, when executed by a processor, such as the processor described above, causes the methods described therein to be performed.

It should be recognized that the embodiments describe methods with an exemplary ordering of method steps. The specific ordering of method steps is however given for illustrative purposes only and should not be construed as binding. For example the ordering of 132 and 133 in the embodiment of FIG. 13 may be exchanged. Other changes of the ordering of method steps may be apparent to the skilled person.

Please note that the division of the units 125 to 126 is only made for illustration purposes and that the present disclosure is not limited to any specific division of functions in specific units. For instance, the units 125 to 126 could be implemented by a respective programmed processor, field programmable gate array (FPGA) and the like.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.

(1) A time-of-flight device comprising a photo-detection layer, and a nanostructure layer arranged on the photo-detection layer, wherein the nanostructure layer has a wavelength filtering function and a focusing function, such that the wavelength range of light incident on the nanostructure layer is reduced to a predefined wavelength range and light emitted from the nanostructure is focused on the photo-detection layer.

(2) The time-of-flight device according to (1), wherein the nanostructure layer includes a nanostructure array including multiple nanostructure areas.

(3) The time-of-flight device according to anyone of (1) to (2), wherein the photo-detection layer includes a photo-detection array including multiple photo-detection pixels.

(4) The time-of-flight device according to anyone of (1) to (3), wherein the nanostructure layer includes a nanostructure array including multiple nanostructure areas and wherein the photo-detection layer includes a photo-detection array including multiple photo-detection pixels, wherein each nanostructure area of the multiple nanostructure areas is centrically aligned with an associated photo-detection pixel of the multiple photo-detection pixels.

(5) The time-of-flight device according to (4), wherein each of the multiple nanostructure areas has the wavelength filtering function and the focusing function, such that the wavelength range of light incident on each of the multiple nanostructure areas is reduced to a predefined wavelength range and light emitted from each of the multiple nanostructure areas is focused on the associated photo-detection pixel of the multiple photo-detection pixels.

(6) The time-of-flight device according to anyone of (1) to (5), wherein the nanostructure layer is electrically tunable to a predefined wavelength range.

(7) The time-of-flight device according to anyone of (1) to (6), wherein the nanostructure layer is adapted for application of a phase control signal.

(8) The time-of-flight device according to (7), wherein by application of the phase control signal a position of an optical axis is adjustable.

(9) The time-of-flight device according to anyone of (7) to (8), wherein by application of the phase control signal a field-of-view of the nanostructure layer is adjustable.

(10) The time-of-flight device according to anyone of (1) to (9), wherein the nanostructure layer is formed based on at least one of: nano-wires, nano-rods, nano-spheres, three-dimensional nano-structures, nano-antennas.

(11) The time-of-flight device according to anyone of (1) to (10), wherein the nanostructure layer includes at least one of: carbon, metal, semiconductor, dielectric.

(12) The time-of-flight device according to anyone of (1) to (11), wherein the nanostructure layer includes at least one nanostructure having a spiral-like shape, wherein the at least one nanostructure is adapted to focus the emitted light in the center of a photo-detection area of the photo-detection layer.

(13) The time-of-flight device according to anyone of (1) to (12), wherein the nanostructure layer includes at least one nanostructure forming a conical shape, wherein the at least one nanostructure is adapted to focus the emitted light in the center of the photo-detection area of a photo-detection layer.

(14) The time-of-flight device according to (13), wherein the nanostructure is formed by a first type of nanostructure elements and by a second type of nanostructure elements, wherein the first type of nanostructure elements are arranged in a first layer and the second type of nanostructure elements are arranged in a second layer, the first and second layer being arranged on top of each other.

(15) The time-of-flight device according to (14), wherein a dielectric layer is arranged between the first layer and the second layer.

(16) The time-of-flight device according to anyone of (1) to (15), wherein the nanostructure layer includes at least one nanostructure having a spherical shape.

(17) The time-of-flight device according to (16), wherein the nanostructure layer includes at least two types of spheres, wherein the diameter of the first type of spheres is larger than the diameter of the second type of spheres

(18) The time-of-flight device according to (17), wherein each sphere of the second type of spheres is surrounded by at least three spheres of the first type of spheres for focusing the emitted light.

(19) The time-of-flight device according to anyone of (17) to (18), wherein the nanostructure layer includes a first layer and a second layer, wherein the spheres of the first type are arranged in the first layer and wherein the spheres of the second type are arranged in the second layer, wherein the first and the second layer are arranged on top of each other.

(20) A time-of-flight system, comprising:
a light source; and
a time-of-flight device, in particular according to anyone of (1) to (19), including:
   a photo-detection layer, and
   a nanostructure layer arranged on the photo-detection layer, wherein the nanostructure layer has a wavelength filtering function and a focusing function, such that the wavelength.

1. An optical stack for image sensing comprising:
a photo detection layer having an array of pixels, the photo detection layer further comprising a plurality of nanostructures on a light-receiving surface of the photo detection layer and sized in a range from 1 nanometer (nm) to 100 nm, the optical stack configured to focus and filter light received by the optical stack onto a pixel of the photo detection layer based on electrical tuning of at least some of the plurality of the nanostructures by the application of control signals to a group of nanostructures connected by wiring, the electrical tuning controlling the optical axis and/or field of view for the group of nanostructures for a pixel.
